(19) United States
(12) Patent Application Publication
(10) Pub. No.: US 2005/0031331 A1
(43) Pub. Date: Feb. 10, 2005

(54) Method and system for focus indication of image capture device

(75) Inventors: Rick Su, Taoyuan (TW); Ying Hao Hsu, Taoyuan (TW)

Correspondence Address: Richard P. Berg, Esq.;c/o LADAS & PARRY, 5670 Wilshire Boulevard, Suite 2100, Los Angeles, CA, 90036-5679, US

(73) Assignee: BENQ CORPORATION

(21) Appl. No.: 10/912,984

(22) Filed: Aug. 5, 2004

(30) Foreign Application Priority Data
Aug. 6, 2003 (TW) 092121544

(51) Int. Cl. G03B 13/36

(52) U.S. Cl. 396/106

(57) ABSTRACT

The present invention provides a focus indication method and system in an image capture device for indicating the photographing state. The method comprises the following steps: press a shutter to be in a first press state to generate a first press signal; start a focus function and a first light emitting state according to the first press signal; then generate a focus complete signal; finish the first light emitting state and start a second light emitting state according to the focus complete signal; generate a second press signal while pressing the shutter to be a second press state; start an image capture function according to the second press signal and finish the second light emitting state before executing the image capture function; generate a third press signal while pressing the shutter to be a third press state; finish the second light emitting state according to the third press signal.

### BACKGROUND OF THE INVENTION

1. Field of the Invention

The present invention relates to a focus indication method and system thereof, especially to a focus indication method applied in an image capture device for indicating the photographing state of the image capture device for a person being photographed.

2. Description of the Prior Art

While image capture devices, such as cameras or digital still cameras, of the prior art are capturing images for a person being photographed, the person usually cannot pose well because of not knowing the present operative state. It is not only confusing while capturing the images, but it also, for the conventional cameras, wastes the cost of negatives and developing photos resulted from taking pictures repeatedly and from undesirable photographs.

U.S. Pat. No. 4,295,724 provides a self-timer for cameras to control the light emitting device (LED) that emits light to indicate the operative state of the self-timer for a person being photographed. The prior art starts a self-timer first and starts to count down by an oscillator. At different time intervals of the countdown, the oscillator outputs different signals to indicate the LED to light in different ways and frequencies, so as to indicate whether the camera is soon going to capture the images for a person being photographed.

However, because the LED of the prior art is only utilized in self-timers and is left unused under general photographing state, it is not economical in terms of efficiency. Furthermore, because the LED of the prior art is controlled by the signal from the oscillator, it can only indicate the length of time before the camera captures the images but not the immediate state of the camera, so the problem of the prior art cannot be solved.

Therefore, the objective of the present invention is to provide a focus indication method and system thereof to solve the problem that the prior art cannot indicate the immediate state of the camera.

### SUMMARY OF THE INVENTION

The present invention provides a focus indication method and system thereof to solve the problem of the prior art.

The present invention provides a focus indication method and system thereof applied in an image capture device for indicating the photographing state of the image capture device for a person being photographed.

The method of the present invention comprises the following steps: press a shutter to be in a first press state to generate a first press signal; start a focus function and a first light emitting state at the same time according to the first press signal; generate a focus complete signal after completing the focus function; finish the first light emitting state and start a second light emitting state according to the focus complete signal; generate a second press signal while pressing the shutter to be in a second press state; start an image capture function according to the second press signal and finish the second light emitting state before executing the image capture function; generate a third press signal while pressing the shutter to be a third press state; finish the second light emitting state according to the third press signal.

The focus indication system and method thereof of the present invention is for improving the self-timer of the prior art, so that the light emitting device can be used to indicate not only the self-photo state but also the immediate state of the image capture device under general photographing state for a person being photographed. Therefore, without increasing additional hardware, a person being photographed can pose accordingly to the immediate state of the camera and avoid taking undesirable pictures. Moreover, the cost of developing ‘failure’ photos can be further reduced.

The advantage and spirit of the invention may be understood by the following recitations together with the appended drawings.

### BRIEF DESCRIPTION OF THE APPENDED DRAWINGS

FIG. 1 is a schematic diagram of a focus indication system of the present invention.

FIG. 2 is a schematic diagram of the inner components of the focus indication system shown in FIG. 1.

FIG. 3 is a flowchart of a focus indication method of the present invention.

### DETAILED DESCRIPTION OF THE INVENTION

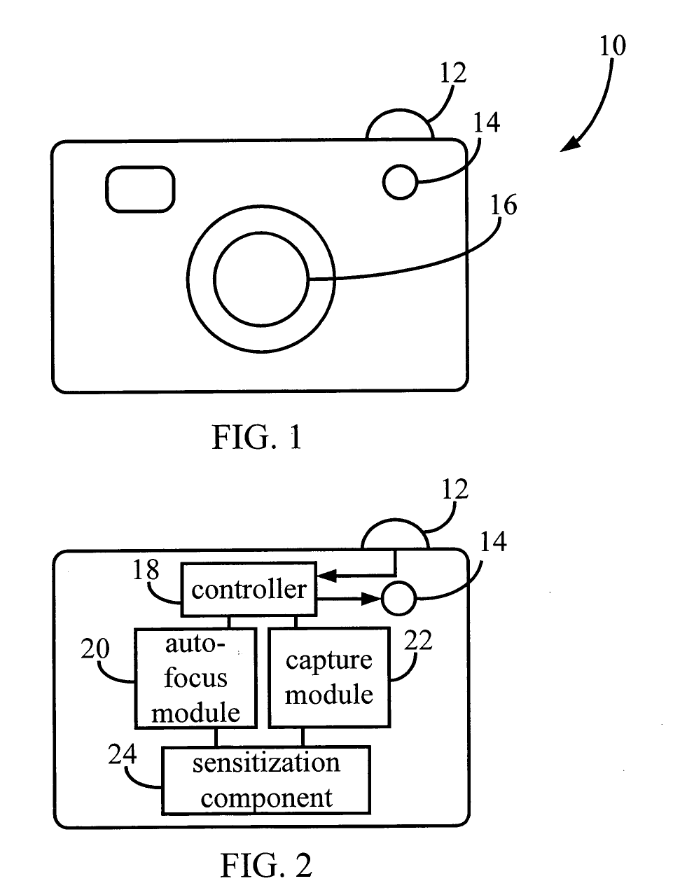

Please refer to FIG. 1. FIG. 1 is a schematic diagram of a focus indication system 10 of the present invention. The present invention provides a focus indication system 10 applied in an image capture device for indicating the photographing state of the image capture device for a person being photographed.

The focus indication system 10 comprises a shutter 12, a lens 16, and a light emitting device 14. The shutter 12 has a plurality of press states according to different press levels, comprising a first press state for generating a first press signal, a second press state for generating a second press signal, and a third press state for generating a third press signal. The first press state is the state that the shutter 12 is half pressed; the second press state is the state that the shutter 12 is completely pressed, and the third press state is the state that the shutter 12 is released or not pressed.

The lens 16 is used for starting a focus function according to the first press signal and generating a focus complete signal after completing the focus function. The lens 16 also starts the image capture function according to the second press signal and generates a finish signal before executing the image capture function. The light emitting device 14 is used for starting a first light emitting state according to the first press signal. At the first light emitting state, the light twinkles with a specific frequency to indicate that the image capture device is focusing on the person being photographed. Then, the light emitting device 14 finishes the first light emitting state and starts the second light emitting state according to the focus complete signal. At the second light emitting state, the light emitting device 14 is fully lighted to indicate that the image capture device completes focusing and prepares to execute the image capture function for the person being photographed. Finally, the light emitting device 14 finishes the second light emitting state according to the finish signal or the third press signal, and the light emitting device 14 is turned off.

The light emitting device 14 further comprises a third light emitting state. At the third light emitting state, the light emitting device 14 is turned off, which represents the lens is not doing anything. When the shutter 12 is in the third press state, as the shutter 12 is not pressed, the light emitting device 14 is kept at the turned off state. Similarly, when the shutter 12 returns to the third press state from the first or the second press state, as the shutter 12 is released to return to the non-pressed state from the state of being fully pressed or half pressed, the light emitting device 14 finishes the second light emitting state. In other words, the light emitting device 14 is turned off while the state of the light emitting device 14 is recovered or the third light emitting state is executed.

Please refer to FIG. 2. FIG. 2 is a schematic diagram of the inner components of the focus indication system 10 shown in FIG. 1. The focus indication system 10 further comprises a controller 18, an auto-focus module 20, a capture module 22, and a sensitization component 24.

While the shutter 12 is at the first, the second, and the third press state respectively, the controller 18 is triggered to generate the first, the second, and the third press signal to control the light emitting device 14 and the lens 16. The controller 18 is further used for receiving the focus complete signal and the finish signal to control the light emitting device 14.

The lens 16 comprises an auto-focus module 20, a capture module 22, and a sensitization component 24. The auto-focus module 20 is used for receiving the first press signal and executing the focus function. The capture module 22 is used for receiving the second press signal and generating the finish signal and an image capture signal. The sensitization component 24 is used for sensitizing an image received by the components in lens 16 and transmitting the image to the capture module 22 according to the image capture signal.

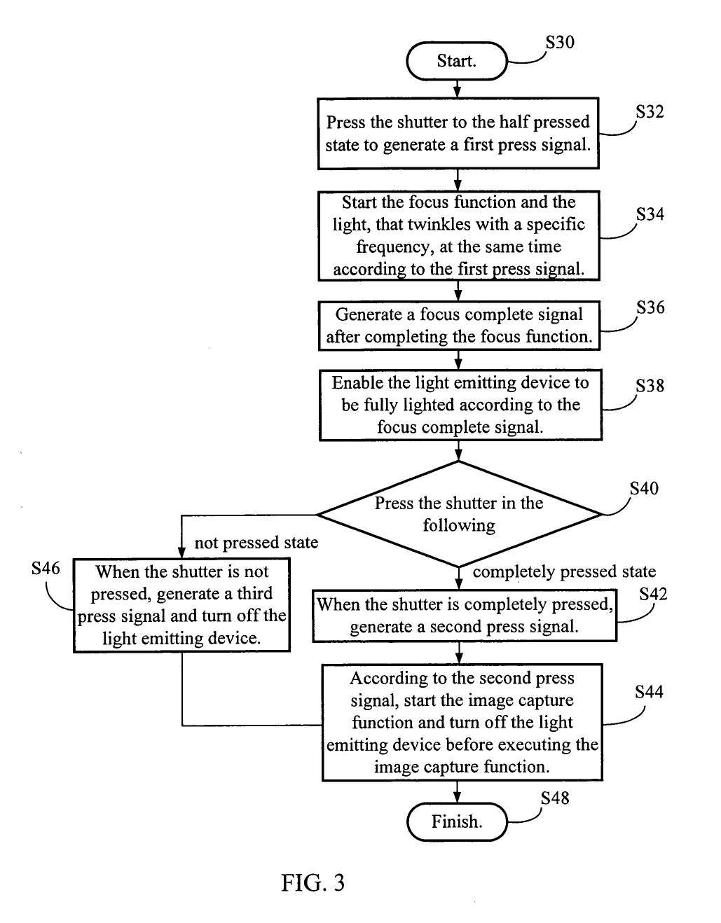

Please refer to FIG. 3. FIG. 3 is a flowchart of a focus indication method of the present invention. According to a preferred embodiment of the present invention, the focus indication method of the present invention comprises the following steps:

Step S30: Start;

Step S32: Press the shutter 12 to the half pressed state to generate a first press signal;

Step S34: Start the focus function and the light, that twinkles with a specific frequency, at the same time according to the first press signal;

Step S36: Generate a focus complete signal after completing the focus function;

Step S38: Enable the light emitting device 14 to be fully lighted according to the focus complete signal;

Step S40: Press the shutter 12 in the following, if the shutter 12 is completely pressed, go to step S42, and if the shutter 12 is not pressed, go to step S46;

Step 42: When the shutter 12 is completely pressed, generate a second press signal;

Step S44: According to the second press signal, start the image capture function and turn off the light emitting device 14 before executing the image capture function;

Step S46: When the shutter is not pressed, generate a third press signal and turn off the light emitting device 14;

Step S48: Finish.

According to another embodiment of the present invention, the focus indication system 10 can further be an immediate indication when it combines with the burst snap shot function. The difference between this embodiment and the method of FIG. 3 is that after step S40 of FIG. 3 completes to focus, and the light emitting device 14 is fully lighted, if the shutter 12 is completely pressed, the light emitting device 14 continues to be fully lighted to indicate that the burst snap shot function is started. On the other hand, if shutter 12 is not pressed, the light emitting device 14 is turned off to indicate that the burst snap shot function is finished.

The present invention provides a focus indication method and system thereof in an image capture device to indicate the photographing state of the image capture device for a person being photographed. The method comprises the following steps: press a shutter to be in a first press state to generate a first press signal; start a focus function and a first light emitting state at the same time according to the first press signal; generate a focus complete signal after completing the focus function; finish the first light emitting state and start a second light emitting state according to the focus complete signal; generate a second press signal while pressing the shutter to be in a second press state; start an image capture function according to the second press signal and finish the second light emitting state before executing the image capture function; generate a third press signal while pressing the shutter to be in a third press state; finish the second light emitting state according to the third press signal.

Compared with the indication system of the prior art, the focus indication system and method thereof of the present invention improves the self-timer of the prior art, so that the light emitting device 14 can be used to indicate not only the self-photo state but also the immediate state of the image capture device under general and burst snap shot state for a person being photographed. Therefore, without additional hardware, a person being photographed would be aware of the immediate state of the camera to pose accordingly, thus avoiding undesirable pictures to be taken. Moreover, the cost of developing ‘failure’ photos can be further reduced.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A method of focus indication applied in an image capture device for indicating the photographing state of the image capture device for a person being photographed, the image capture device comprising a shutter, a light emitting device, and a lens, the shutter comprising a first press state, a second press state, and a third press state, the light emitting device being used for emitting a light to the person being photographed and comprising a first light emitting state and a second light emitting state, the lens being used for processing a focus function and an image capture function, the method comprising:
pressing the shutter to be the first press state to generate a first press signal; starting the focus function and the first light emitting state at the same time according to the first press signal;
generating a focus complete signal after completing the focus function;
finishing the first light emitting state and starting the second light emitting state according to the focus complete signal;
generating a second press signal while pressing the shutter to be the second press state;
starting the image capture function according to the second press signal and finishing the second light emitting state before executing the image capture function;
generating a third press signal while pressing the shutter to be the third press state; and
finishing the second light emitting state according to the third press signal.

2. The focus indication method of claim 1, wherein the first press state is the state that the shutter is half pressed, the second press state is the state that the shutter is completely pressed, and the third press state is the state that the shutter is not pressed.

3. The focus indication method of claim 1, wherein at the first light emitting state, the light twinkles with a specific frequency to indicate that the image capture device is focusing on a person being photographed.

4. The focus indication method of claim 1, wherein at the second light emitting state , the light emitting device is fully lighted to indicate that the image capture device completes focusing and prepares to execute the image capture function for a person being photographed.

5. A system of focus indication applying in an image capture device for indicating the photographing state of the image capture device for a person being photographed, the focus indication system comprising:
a shutter having a plurality of press states according to different press levels, comprising:
a first press state for generating a first press signal;
a second press state for generating a second press signal; and
a third press state for generating a third press signal;
a lens for
starting a focus function according to the first press signal;
generating a focus complete signal after completing the focus function; and
starting the image capture function according to the second press signal and generating a finish signal before executing the image capture function; and
a light emitting device for
starting a first light emitting state according to the first press signal;
finishing the first light emitting state and starting the second light emitting state according to the focus complete signal;
finishing the second light emitting state according to the finish signal; and
finishing the second light emitting state according to the third press signal.

6. The focus indication system of claim 5, wherein the first press state is the state that the shutter is half pressed, the second press state is the state that the shutter is completely pressed, and the third press state is the state that the shutter is not pressed.

7. The focus indication system of claim 5, wherein at the first light emitting state, the light twinkles with a specific frequency to indicate that the image capture device is focusing on a person being photographed.

8. The focus indication system of claim 5, wherein at the second light emitting state , the light emitting device is fully lighted to indicate that the image capture device completes focusing and prepares to execute the image capture function for a person being photographed.

9. The focus indication system of claim 5, further comprising a controller for generating the first, the second, and the third press signal to control the lens and the light emitting device while the shutter is at the first, the second, and the third press state respectively, the controller further being used for receiving the focus complete signal and the finish signal to control the light emitting device.

10. The focus indication system of claim 5, wherein the lens comprises an auto-focus module for receiving the first press signal and executing the focus function.

11. The focus indication system of claim 10, wherein the lens further comprises a capture module for receiving the second press signal, and generating the finish signal and an image capture signal.

12. The focus indication system of claim 11, wherein the lens further comprises a sensitization component for sensitizing an image received by the lens and transmitting the image to the capture module according to the image capture signal.

13. A method of focus indication applying an image capture device for indicating the photographing state of the image capture device for a person being photographed, the image capture device comprising a shutter, a light emitting device, and a lens, the shutter comprising a first press state, a second press state, and a third press state, the light emitting device being used for emitting a light to the person being photographed and comprising a first light emitting state, a second light emitting state, and a third light emitting state, the lens being used for processing a focus function and an image capture function, the method comprising the following steps: pressing the shutter to be the first press state to generate a first press signal, starting the focus function and the first light emitting state at the same time according to the first press signal, the lens generating a focus complete signal after completing the focus function, finishing the first light emitting state and starting the second light emitting state according to the focus complete signal; at this time, when pressing the shutter to be the second press state, generating a second press signal for the light emitting device to start the image capture function and finishing the second light emitting state before executing the image capture function; when pressing the shutter to be the third press state, generating a third press signal for the light emitting device to process the third light emitting state.

14. The focus indication method of claim 13, wherein the first press state is the state that the shutter is half pressed, the second press state is the state that the shutter is completely pressed, and the third press state is the state that the shutter is not pressed.

15. The focus indication method of claim 13, wherein at the first light emitting state, the light twinkles with a specific frequency to indicate that the image capture device is focusing on a person being photographed.

16. The focus indication method of claim 13, wherein at the second light emitting state, the light emitting device is fully lighted to indicate that the image capture device completes focusing and prepares to execute the image capture function for a person being photographed.

17. The focus indication method of claim 13, wherein at the third light emitting state, the light emitting device is turned off, which represents the lens doesn't do anything.

18. The focus indication method of claim 13, the image capture device further comprising a controller for generating the first, the second, and the third press signal to control the lens and the light emitting device while the shutter is at the first, the second, and the third press state respectively, the controller further being used for receiving the focus complete signal and the finish signal to control the light emitting device.

19. The focus indication method of claim 13, wherein the lens comprises an auto-focus module for receiving the first press signal and executing the focus function.

20. The focus indication method of claim 19, wherein the lens further comprises a capture module for receiving the second press signal, and generating the finish signal and an image capture signal.

21. The focus indication method of claim 20, wherein the lens further comprises a sensitization component for sensitizing an image received by the lens and transmitting the image to the capture module according to the image capture signal.
